(19) United States
(12) Patent Application Publication
(10) Pub. No.: US 2005/0123767 A1
(43) Pub. Date: Jun. 9, 2005

(54) Pillow packaged for display media

(75) Inventors: Tin Pham, San Jose, CA (US); Phillip Ulrich, Flagstaff, AZ (US); Y. Martin Lu, Mundelein, IL (US)

Correspondence Address: PILLSBURY WINTHROP SHAW PITTMAN, LLP, P.O. BOX 10500, MCLEAN, VA, 22102, US

(73) Assignee: Xerox Corporation

(21) Appl. No.: 11/006,942

(22) Filed: Dec. 8, 2004

Related U.S. Application Data
(60) Provisional application No. 60/528,144, filed on Dec. 8, 2003.

(51) Int. Cl. B32B 9/04

(52) U.S. Cl. 428/411.1

(57) ABSTRACT

A display medium with a multilayered “pillow” structure is provided herein. The display can be form of an elastomer layer with rotatable elements, sandwiched between a “pillow” structure that includes a moisture-resistant conductive transparent layer on one side and a thin, polyester film on the other side. The pillow may be attached to an electric backplane so that the polyester film is operably configured between the pillow containing the elastomer and the electric backplane.

This application claims priority under USC §119(e) of U.S. Provisional application Ser. No. 60/528,144, filed Dec. 8, 2003.

### BACKGROUND

Disclosed is a display medium with a multilayered “pillow” structure. The medium comprises an electronic device having rotatably addressable elements.

Signs that are commonly used are based upon printed materials, paper, plastic, metal, and other fixed materials, and such signs are therefore not programmable. Accordingly, they are not easily changeable. In an attempt to overcome this problem, electronically programmable and/or controllable signs have been in existence for many years. For example, liquid crystal diode (LCD) displays, cathode ray tube (CRT) displays and other electrically-addressable displays will display an image in response to applied electric signals or fields. However, such signs typically require a large amount of electricity, since they must provide illumination in order to be visible to a viewer.

Various types of electric writeable media, commonly known as rotatable element displays or electric paper displays, also exist in the prior art. One example of a rotatable element display includes a polymer substrate and bichromal rotatable elements such as balls or cylinders that are in suspension with an enabling fluid and are one color, such as white, on one side and a different color, such as black, on the other. Examples of such rotatable element displays are described in U.S. Pat. No. 5,723,204 (Stefik) and U.S. Pat. No. 5,604,027 (Sheridon), each of which is incorporated herein by reference in its entirety. Under the influence of an electric field, the elements rotate so that either the white side or the black side is exposed.

Rotatable element displays are different from other known displays, such as LCDs and CRTs in that rotatable element displays are suitable for viewing in ambient light and they retain an image indefinitely in the absence of an applied electric field, and they can be made to be very lightweight and/or flexible. For further features of such displays, see U.S. Pat. No. 5,389,945 (Sheridon), incorporated herein by reference in its entirety. An example of such a display is a SmartPaper™ display from Gyricon, LLC, of Ann Arbor, Mich.

Another type of electric writeable media is known as an electronic ink display, such as the one described in U.S. Pat. No. 6,518,949 (Drzaic), which is incorporated herein by reference. An electronic ink display includes at least one capsule filled with several particles, made of a material such as titania, and a dyed suspending fluid. When a direct-current electric field of an appropriate polarity is applied across the capsule, the particles move to a viewed surface of the display and scatter light. When the applied electric field is reversed, the particles move to the rear surface of the display and the viewed surface of the display then appears dark.

Yet another type of electric writeable media, also described in U.S. Pat. No. 6,518,949 (Drzaic), includes a first set of particles and a second set of particles in a capsule. The first set of particles and the second set of particles have contrasting optical properties, such as contrasting colors, and can have, for example, differing electrophoretic properties. The capsule also contains a substantially clear fluid. The capsule has electrodes disposed adjacent to it connected to a voltage source, which may provide an alternating-current field or a direct-current field to the capsule. Upon application of an electric field across the electrodes, the first set of particles moves toward a first electrode, while the second set of particles moves toward a second electrode. If the electric field is reversed, the first set of particles moves toward the second electrode and the second set of particles moves toward the first electrode. Other examples of writeable media include liquid crystal diode displays, encapsulated electrophoretic displays, and other displays.

U.S. Pat. No. 5,739,801 (Sheridon), the disclosure of which is entirely incorporated herein by reference, discloses a multithreshold electrical twisting ball display device. The device is composed of electrically and optically anisotropic spheroidal balls of at least two different rotation thresholds, disposed in an elastomer substrate, together with an addressing electrode assembly. The addressing electrode assembly allows a region of the substrate to be selected in which at least one ball of the first set and at least one ball of the second set are disposed, and first and second electric fields to be applied to the region thus selected, each of the first and second electric fields extending throughout the region. The first field facilitates a contemporaneous rotation of balls of both the first and second sets rotatably disposed in the region. The second electric field facilitates a rotation of balls of the second set rotatably disposed in the region, without facilitating a rotation of any ball of the first set rotatably disposed in the region.

A bichromal display such as that disclosed in U.S. Pat. No. 5,739,801 (Sheridon) may include a twisting-ball display, rotary ball display, particle display, dipolar particle light valve, etc., each of which is referred to herein as a “rotatable element display”. Such a display offers a technology for making a form of electric paper. Briefly, a rotatable element display is an addressable display made up of a multiplicity of optically anisotropic balls, each of which can be selectively rotated to present a desired face to an observer. For example, a rotatable element display can incorporate balls each having two distinct hemispheres, one black and the other white, with each hemisphere having a distinct electrical characteristic so that the balls are electrically as well as optically anisotropic. The black-and-white balls are embedded in a sheet of optically transparent material, such as an elastomer layer, that contains a multiplicity of spheroidal cavities and is permeated by a transparent dielectric fluid, such as a plasticizer. The fluid-filled cavities accommodate the balls, one ball per cavity, so as to prevent the balls from migrating within the sheet. A ball can be selectively rotated within its respective fluid-filled cavity, for example by application of an electric field, so as to present either the black or the white hemisphere to an observer viewing the surface of the sheet. Thus, by application of an electric field addressable in two dimensions (as by a matrix addressing scheme), the black and white sides of the balls can be caused to appear as the image elements (e.g., pixels or subpixels) of a displayed image.

Rotatable element display devices generally include a backplane layer of a semiconductor material, an elastomer layer with rotatable elements, such as that known as Smartpaper™ from Gyricon, LLC, and optionally a layer of glass or polyester, acting as a conductive transparent layer through which an observer views the displayed message or design. It is found that the display quality in terms of contrast ratio and brightness may deteriorate over time with various rotatable element display devices. The deterioration is due mainly to the interaction of the elastomer layer with the electric backplane. It has been found that the addition of a thin polymeric or polyester layer in between the electric backplane and the elastomer layer with rotatable elements layer enhances the lifetime of rotatable element display devices.

Known rotatable element displays include those described in U.S. Pat. Nos. 4,126,854, 4,143,103, 5,604,027, 5,717,514, 5,894,367, 5,739,801, 6,055,091, 6,559,820, and 6,507,333, each of which is incorporated herein by reference in its entirety. Rotatable element displays comprise at least the elements of an elastomer layer having rotatable elements or other addressable material, and an electric backplane through which a voltage is supplied to configure the rotatable elements, resulting in various end-use display applications including writing, re-writing or erasing an “electronic paper” sheet.

### SUMMARY

Aspects disclosed herein include
a media comprising a multilayer pillow structure, the pillow structure comprising a first layer including addressable elements and having a first surface and a second surface; a second layer disposed over the first surface of the first layer; a third layer disposed on the second surface of the first layer; and a fourth layer attached to the pillow structure;
a display media comprising a multi-pillow structure comprising two or more layers and at least one layer is an elastomeric layer comprising rotatable elements and a polymer layer, wherein the pillow structures are separated by a polymeric layer; and a top layer and a bottom layer encapsulating the multi-pillow structure;
a method comprising forming a pillow structure comprising an addressable layer having a first surface and a second surface; forming a first layer over the first surface of the addressable layer; forming a second layer on the second surface of the addressable layer; forming a third layer; and attaching the third layer to the pillow structure;
a method comprising forming a multi-pillow structure comprising which comprises stacking two or more pillow structures and attaching the pillow structure to each other with intervening layers therebetween; and encapsulating the multi-pillow structure between a top and a bottom layers; wherein each pillow structure comprises a transparent conductive layer, an elastomer layer and a polymer layer and an adhesive between the transparent conductive layer and the polymer layer which encapsulates the elastomer layer.

### BRIEF DESCRIPTION OF DRAWINGS

FIG. 1 is a schematic drawing illustrating an embodiment comprising a multilayered structure of a pillow package for an electrically writeable media.

### DETAILED DESCRIPTION

In embodiments there is illustrated:
a display medium with a multilayered “pillow” structure, along with methods of construction and use thereof. The medium comprises an electronic device having rotatably addressable elements.

The embodiments may employ any suitable rotatable elements to make up the elastomer display medium layer, for example, multichromal balls. Rotatable element displays are made up of bichromal balls that are black in one hemisphere and white in the other. Other kinds of balls are also known. For example, U.S. Pat. No. 4,261,653 (Goodrich) shows a multilayer ball, although it is made at least in part from glass and its use depends on a scheme involving high-frequency electric fields. U.S. Pat. No. 5,344,594 (Sheridon), which is incorporated by reference, indicates how a multi-stream fabrication method for bichromal balls can be extended for use in making certain multilayer, multichromal balls. Rotatable element displays may also use multichromal balls in canted fields. U.S. Pat. No. 5,708,525 (Sheridon), which is incorporated by reference, discloses various techniques in which to fabricate and use rotatable multichromal balls.

Exemplary methods for continuously fabricating anisotropic rotational elements, such as hemispherically bichromal spheres, are shown in U.S. patent application Ser. No. 10/397,017 by Lu, filed on Mar. 25, 2003 and incorporated herein by reference in its entirety. Such a method may include producing a continuous flow of colored, hardenable liquid material by an extruder which receives and melts the base polymer and mixes the molten polymer with a first pigment. A second continuous flow of differently colored, hardenable liquid material is produced by a second extruder which receives and melts the base polymer and mixes the molten polymer with a second pigment. The method further provides for pumping both flows of the colored hardenable liquid material to opposing surfaces of a spinning disk at a substantially uniform consistency, temperature and flow rate. The centrifugal force of the spinning disk causes both flows of the colored hardenable liquid materials to form a reservoir outboard of the spinning disk from which bichromal streams of the hardenable liquid material extrude. The ends of the bichromal streams become unstable, break off, and harden to form bichromal spheres.

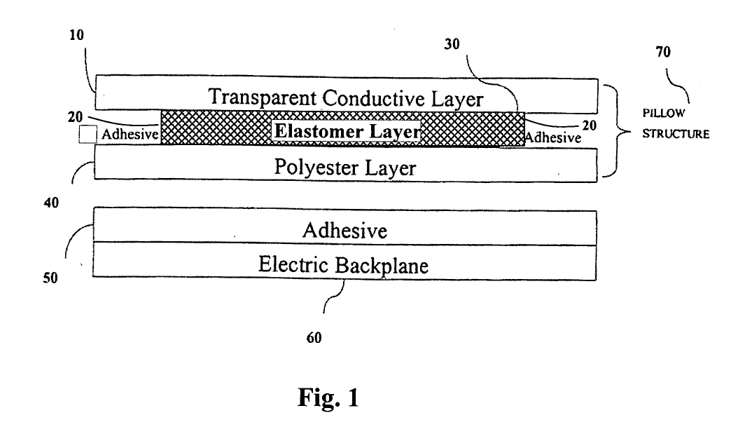

Referring to FIG. 1, the black-and-white balls may be embedded in a sheet of optically transparent material, such as an elastomer layer 30, that contains a multiplicity of spheroidal cavities and is permeated by a transparent dielectric fluid, such as a plasticizer. This multiplicity of spheroidal cavities is permeated by a transparent dielectric fluid will be referred to as the “elastomer layer 30” hereinafter. The fluid-filled cavities accommodate the balls, one ball per cavity, so as to prevent the balls from migrating within the sheet. A ball can be selectively rotated within its respective fluid-filled cavity, for example by application of an electric field, so as to present either the black or the white hemisphere to an observer viewing the surface of the sheet.

Different parts, or segments of a rotatable element may be black, white, clear (that is, essentially transparent and without chroma, like water or ordinary window glass); a transparent color (e.g., transparent red, blue, or green, as for certain additive color applications; transparent cyan, magenta, or yellow, as for certain subtractive color applications); an opaque color of any hue, saturation, and luminance; any shade of gray, whether opaque or translucent; and so forth. “Achromatic colors”, which refer to colors essentially lacking in chroma, that is, to black, white, gray, and clear, and “chromatic colors”, which to refer to other colors, including red, orange, yellow, green, blue, indigo, violet, cyan, magenta, pink, brown, beige, etc. are suitable in the present invention.

The balls for the rotatable element display may be made with segments of different electrical properties, so that the balls can be oriented to any of the multiple possible orientations by application of suitable electric fields. Because the segments of rotatable elements are made with different electrical properties, the balls, for example, may be electrically anisotropic. When a suitable electric field is applied in the vicinity of a ball, the ball tends to rotate, with its direction of rotation and its final orientation being substantially determined by its electrical anisotropy. The ball retains its orientation even after the applied field is removed.

Some illustrative examples of plastic materials suitable for making rotatable element segments are polyethylene, polyester, carnuba wax, and castor wax. (Although waxes are not polymerized hydrocarbons, they are, strictly speaking, plastic materials.) Other materials, such as epoxy, can also be suitable. The same or similar materials can be used for both transparent and nontransparent ball segments, with suitable coloring agents being added in the case of the nontransparent segments. For transparent segments, the materials can be chosen to have refractive indices closely matching that of the plasticizer liquid used to swell the elastomer sheet.

In general, a rotatable element display can be made in various sizes and shapes, and using various kinds of materials for the rotatable elements, elastomer sheet, and plasticizer fluid. For instance, the rotatable element display device may be made about the size of an ordinary sheet of paper by using, for example, an 8.5 by 11 inch sheet of SYLGARD® elastomer material of 20 mils (thousandths of an inch) thickness with ISOPAR L plasticizer and highlight color balls of 100 micron diameters with center segments 50 microns thick, the top segment of each ball can be made from carnuba wax material, the bottom can be made from castor wax material, and the three interior segments can be made from castor wax colored with carbon black, titanium dioxide, and a chromatically colored dye or pigment to provide, respectively, the black, white, and highlight colors of the interior segments.

The elastomer, which may be a material such as Dow Corning Sylgard® 184, has a bulk resistivity in excess of 10¹⁶ ohm-centimeters. The resistivity can be lowered depending on the requirements of the display, by the addition of chemicals or dopants that promote conductivity such as fatty acid salts, for example, aluminum stearate. These chemicals may be added to the uncured elastomer. Likewise, the substrate can be altered as a low conductivity polymer with a similar time constant as the suitably modified elastomer.

Many different dyes and pigments can be suitable for use as coloring agents to provide chromatic and achromatic colors in rotatable balls and segments of rotatable balls, depending on the application and on the material or materials used in constructing the balls. By way of example, if the balls are made from wax materials, dyes that can be used include BAKER CHEMICAL Cresyl violet blue, BAKER CHEMICAL Rhodamine 6G, DUPONT Rhodamine BI, DUPONT Spirit Blue NS, DUPONT Victoria Blue B base, ALLIED CHEMICALS Iosol Blue, EASTMAN Acridine orange, CALCO OIL blue N, and CALCO OIL black; and pigments that can be used include DUPONT R900 titanium dioxide, FERRO 6331 black pigment, CABOT MOGUL L carbon black, and CABOT MONARCH 1000 carbon black.

The rotatable elements in the elastomer are contained in any suitable assembly. Referring to the embodiment illustrated in FIG. 1, the elastomer layer 30 with the rotatable elements must be physically contained and a voltage must be applied to it in order to configure the rotatable elements. The elastomer layer 30 can be used with known devices, and is located over an electric backplane 60, which facilitates the voltage to configure the rotatable elements. This electric backplane 60 forms the base substrate for the elastomer layer 30. Optionally, additional layers can be added such as a conductive transparent layer 10, which may be placed over the elastomer layer 30 to contain and support the elastomer layer 30. This conductive transparent layer 30 is formed with any material that is suitably transparent, such that an observer may view the elastomer layer 30 with the rotatable elements. The conductive transparent layer may comprise a glass, plastic, polyester or any other transparent material.

One example of the backplane 60 assembly is found in U.S. Pat. No. 5,708,525 (Sheridon). The rotatable elements in the elastomer layer 30 be may contained in an electrode assembly. The backplane 60 may be any conductive material through which a voltage is applied.

In another embodiment, the conductive transparent layer 10 over the elastomer layer 30 is made of any material that acts to physically contain the elastomer in the display device and has suitable transparent properties. The conductive transparent layer 10 may be, for example, a glass or polymeric layer through which an observer views the elastomer layer 30 containing the rotatable elements.

The electric backplane 60 or conductive transparent layer may be made by depositing a conductive material on a glass or plastic backing or substrate. In one embodiment, the conductive material is indium/tin oxide (ITO), which can be applied to glass by methods such as sputtering. A tin oxide (NESA glass) coating or other coating can also be used.

Voltages may be applied to the electric backplane 60 for erasing and writing applications. A voltage applied to the backplane 60, for example, produces the electric field. A voltage may be applied in any known manner, by any suitable device. The power draw can be low in rotatable element devices.

For example, different segments of the balls may be made with different electrical properties. By applying an electric field to the plane of the elastomer sheet in which the balls are embedded, the balls can be oriented to present various messages or designs to an observer.

The display devices may be used in connection with other known applications. For example, the use of an overlay transparencies, an architectural screen, variable angled (canted) electric fields, or multiple color balls may be used in connection with a display device such as that described in U.S. Pat. No. 5,708,525 (Sheridon).

In addition to one or more of the elements described above, display devices may comprise a polymeric layer, such as a polyester layer 40, located between the electric backplane 60 and the elastomer layer 30. Suitable materials for this polymeric layer may include polyesters, polycarbonates, polypropylene, or any other suitable polymeric thin film. For purposes of simplicity, this polymeric layer will be labeled “polyester layer”, but it is understood that this layer may comprise any suitable polymer. This polyester layer 40 avoids direct contact between the elastomer layer 30 and the electric backplane 60. The display devices with the polyester layer 40 provide enhanced display properties, including improved contrast ratio and extended lifetime.

This polyester layer 40 is typically thin, with a thickness of about 0.5 mils (thousandth of an inch) to about 7 mils. The polyester layer 40 may be a plain film attached to the electric backplane 60 by an adhesive film or attached by uniformly coating the polyester film as an adhesive layer such as layer 50. The polyester layer 40 may be attached to the electric backplane 60 with adhesives, coatings or additives. In various embodiments, the polyester layer 40 and any adhesives necessary may be clear, white, black, or any color depending on the type of display and performance features desired. The polyester layer 40 is substantially contiguous with the surface of the elastomer layer 30, and may be uncoated.

Suitable polyesters for the polyester layer 40 include those produced from aromatic, aliphatic or cycloaliphatic dicarboxylic acids of about 4-20 carbon atoms, and aliphatic or alicyclic glycols having from about 2-24 carbon atoms. Examples of suitable dicarboxylic acids include terephthalic, isophthalic, phthalic, naphthalene dicarboxylic acid, succinic, glutaric, adipic, azelaic, sebacic, fumaric, maleic, itaconic, 1,4-cyclohexanedicarboxylic, sodiosulfoisophthalic, and mixtures thereof. Examples of suitable glycols include ethylene glycol, propylene glycol, butanediol, pentanediol, hexanediol, 1,4-cyclohexanedimethanol, diethylene glycol, other polyethylene glycols, and mixtures thereof. Such polyesters are well known in the art and may be produced by well-known techniques, e.g., those described in U.S. Pat. Nos. 2,465,319 and 2,901,466. Continuous matrix polyesters are those having repeat units from terephthalic acid or naphthalene dicarboxylic acid and at least one glycol selected from ethylene glycol, 1,4-butanediol and 1,4-cyclohexanedimethanol. Poly(ethylene terephthalate) (PET) may be more desirable.

Another embodiment of the present invention is a pillow structure 70, one embodiment of which is shown in FIG. 1. The pillow structure 70 includes the elastomer layer 30, containing the rotatable elements or another bichromal medium, with a polyester layer 40 located on one side of the elastomer layer 30 and a conductive transparent layer located on the other side of the elastomer layer 30. The conductive transparent layer may be made of polyester, such as indium tin oxide (ITO) coated polyester, or another suitable material. Optionally, an additional layer such as a glass or plastic protective layer, may be included on top of the cover sheet. The pillow structure 70 may be placed onto the electric backplane 60 in any suitable manner such by attaching the pillow structure by way of an adhesive 50. The electric backplane 60 may contact the polyester layer 40 via a polymer layer such as an adhesive layer 50.

In one embodiment, the elastomer layer 30 comprising rotatable elements may be encapsulated in the pillow structure 70 by applying a sealant 20 such as an adhesive, between the transparent conductive layer 10 and the polyester layer 40 and along the boarder of the pillow to seal the layers together. In one embodiment, pillow package comprising, for example, layers 10, 30, 40 can further be formed separately and further comprising layer 50; the pillow package can then be provided to a substrate 60 as a single assembly and in one step so as to facilitate the making of the display device. Alternatively, the pillow package can be assemble by providing layer 40 and 50 as a single composite film prior to attaching the elastomer layer 30. In this embodiment, the composite films can be made of, for example, polyester, polycarbonate, polypropylene or any other polymer film and can be applied to the substrate 60 prior to assembling the remaining layers of the pillow package or together after attaching the remaining layers of the pillow package.

FIG. 1 represents a display device according to one embodiment of the present invention. Displayed in FIG. 1 is the pillow structure 70 including its multiple layers and adhesive layer 50 and a backplane 60. The pillow structure 70 comprises a conductive transparent layer 10, the elastomer layer 30 with rotatable elements, and the polyester layer 40, which may be a PET film, for example. This polyester layer 40 can be anywhere from about 0.5 mils (thousandth or an inch) to about 7 mils depending on processing constraints or ultimate end-use application parameters. The pillow structure 70 may be constructed separately, and then it may be attached to the electric backplane 60 with any suitable adhesive layer 50.

In another embodiment, there is provided a display device comprising an elastomer layer 30 with rotatable elements or bichromal medium with two pillow layers, located on either side of the elastomer layer 30, the pillow layers forming an encapsulated elastomer layer 30. This encapsulated elastomer layer 30 may then be placed onto a electric backplane 60. The pillow layer that will contact the backplane 60 is made of, for example, polyester. Optionally, a display device with the encapsulated elastomer layer 30 may contain a conductive transparent layer.

A method for building an electronic display comprises building a pillow structure 70 that includes a thin polyester layer 40, elastomer layer 30 with rotatable elements or another bichromal medium, and a conductive transparent layer and then attaching the pillow structure 70 to the electric backend. The pillow structure 70 may be attached to the backplane 60 by a process, such as coating, adhesion, or lamination.

An alternative method of building an electronic display comprises providing a polyester to an electric backplane 60 using a lamination process, placing the elastomer layer 30 with the rotatable balls or other bichromal medium onto the polyester layer 40 and sealing the top of the elastomer layer 30 with a conductive transparent layer. Alternatively, a display device may be assembled by encapsulating an elastomer layer 30 on either side with a polyester layer 40 and then attaching the encapsulated elastomer to a electric backplane 60. The encapsulated elastomer layer may be attached by any known process, such as coating, adhesion, or lamination.

The display devices exhibit extended lifetime with enhanced contrast ratio and brightness properties. Additional benefits include the ability to replace rotatable display elements independently of the electronic backplane 60. Display devices of the present invention including the pillow structure 70 or the encapsulated elastomer layer which provide protection to the elastomer layer 30 and rotatable elements and prevent direct contact and interaction between the electric backplane 60 and the elastomer layer 30.

In another embodiment, the methods of building display devices exhibit several improvements over known methods in which the display device assembly may be sub-assembled. The display pillow structure 70 including the elastomer layer 30 with bichromal material and the polyester layer 40 and the encapsulated elastomer layer 30 may be constructed without the electric backplane 60. Building these structures separately reduces lead-time for sign display device building. The structure of the pillow structure 70 or encapsulated elastomer enables a user to access and maintain these structure without interference with the electric backplane 60.

In alternate embodiments, a display device may comprise an elastomer layer 30 and a electric backplane 60 and a polyester layer 40 located between them, and may also include additional barrier and optical performance enhancement films or layers in between the elastomer layer 30 and the electric backplane 60. These additional barrier layers may be comprised of any suitable polymer or adhesive material.

In one embodiment, the polyester layer 40 of the pillow structure 70 may be laminated onto the electric backplane 60. The lamination process may be with a two roll or platen press laminator. The thickness gap of the rollers are set so that there is not too much pressure on the pillow structure 70. Typically, in lamination processes, the thickness is equal to the thickness of the entire structure being laminated. In another embodiment, the pillow structure 70 may be attached to the backplane 60 with a double sided adhesive tape or any other suitable adhesive. Preferably, this adhesive has a thickness in the range of about 0.5 mils (thousandth or an inch) to about 5 mils, depending on processing constraints or ultimate end-use application parameters.

It will be appreciated that variations of the above-disclosed embodiments and other features and functions, or alternatives thereof, may be desirably combined into many other different devices or applications. Also that various presently unforeseen or unanticipated alternatives, modifications, variations or improvements therein may be subsequently made by those skilled in the art which are also intended to be encompassed by the following claims.

1. A media comprising
a multilayer pillow structure, said pillow structure comprising
a first layer including addressable elements and having a first surface and a second surface;
a second layer disposed over said first surface of said first layer;
a third layer disposed on said second surface of said first layer; and
a fourth layer attached to said pillow structure.

2. The media in accordance with claim 1, wherein said addressable elements comprise rotatable elements.

3. The media in accordance with claim 1, wherein said first layer comprises an elastomer.

4. The media in accordance with claim 1, wherein said second layer comprises a conductive layer.

5. The media in accordance with claim 1, wherein said second layer comprises a transparent layer.

6. The media in accordance with claim 1, wherein said second layer comprises a moisture-resistant material.

7. The media in accordance with claim 1, wherein said third layer comprises polymeric material.

8. The media in accordance with claim 1, wherein said fourth layer comprises a conductive backplane.

9. The media in accordance with claim 1, wherein said fourth layer is adhesively attached to said pillow structure.

10. A media in accordance with claim 1 comprising
a multi-pillow structure, wherein said pillow structures are separated by a polymeric layer; and
a top layer and a bottom layer encapsulating said multi-pillow structure.

11. A method comprising
forming a pillow structure, which comprises
a. forming an addressable layer having a first surface and a second surface;
b. forming a first layer over said first surface of said addressable layer;
c. forming a second layer on said second surface of said addressable layer; forming a third layer; and
attaching said third layer to said pillow structure.

12. The method in accordance with claim 11, wherein said attaching said third layer to said pillow structure is accomplished using an adhesive.

13. The method in accordance with claim 11, wherein said attaching said third layer to said pillow structure is accomplished by lamination.

14. A method comprising
forming a multi-pillow structure which comprises
a. forming two or more pillow structures in accordance with claim 11;
b. stacking said two or more pillow structures and attaching to each other with intervening layers therebetween;
forming a top layer;
forming a bottom layer; and
encapsulating said multi-pillow structure between said top and bottom layers.

15. The method in accordance with claim 14, wherein said attaching said pillow structures to each other is accomplished using an adhesive.

16. The method in accordance with claim 14, wherein attaching said pillow structures to each other is accomplished by lamination.

17. The method in accordance with claim 11, wherein attaching said third layer to said pillow structure is accomplished by lamination.

18. The method in accordance with claim 14, wherein attaching said multi-pillow structure to an electric backplane is accomplished using an adhesive.

19. The method in accordance with claim 11, wherein said encapsulating said multi-pillow structure is accomplished by lamination.

20. The media of claim 1, wherein the media is a display media and wherein at least one of the layers of the pillow comprises rotatable elements.
